(19) United States
(12) Patent Application Publication
(10) Pub. No.: US 2024/0011943 A1
(43) Pub. Date: Jan. 11, 2024

(54) METHOD FOR REMOTE CONTROL OF ELECTROPHORESIS APPARATUS BASED ON IMAGE RECOGNITION

(71) Applicant: SHANGHAI TANON LIFE SCIENCE CO., LTD., Shanghai (CN)

(72) Inventor: Chengwei MENG, Shanghai (CN)

(73) Assignee: SHANGHAI TANON LIFE SCIENCE CO., LTD., Shanghai (CN)

(21) Appl. No.: 18/021,808

(22) PCT Filed: Mar. 25, 2021
(86) PCT No.: PCT/CN2021/082909

§ 371 Date: Feb. 17, 2023

(30) Foreign Application Priority Data
Sep. 28, 2020 (CN) 202011044393.8

(51) Int. Cl. G01N 27/447; G06V 20/40; G05B 19/042

(52) U.S. Cl. CPC G01N 27/44704; G06V 20/48; G05B 19/0423

(57) ABSTRACT

A method for remote control of an electrophoresis apparatus based on image recognition, comprising: connecting an electrophoresis apparatus to a camera device and an electrophoresis tank, and controlling the camera device and the electrophoresis tank by the electrophoresis apparatus; recording an electrophoresis process of the electrophoresis tank in real time by the camera device, and sending a video to the electrophoresis apparatus; sending the video to a remote control terminal by the electrophoresis apparatus; capturing video images frame by frame and then performing an analysis and comparison, by the remote control terminal; and when the electrophoresis process of the electrophoresis tank in one frame of image reaches an electrophoresis image end standard line set by the remote control terminal, sending, by the remote control terminal, a control signal to the electrophoresis apparatus and controlling the electrophoresis apparatus to stop an output, so as to stop electrophoresis of the electrophoresis tank.

### 1. TECHNICAL FIELD

The invention belongs to the technical field of electrophoresis apparatuses, and particularly relates to a method for remote control of an electrophoresis apparatus based on image recognition.

### 2. DESCRIPTION OF RELATED ART

At present, when electrophoresis apparatuses produced around the world are used, the voltage, current and time (an estimated electrophoresis end time) must be set on the spot. Because the timing function of the electrophoresis apparatuses is based on the electrophoresis test end time estimated by testers according to test experience, the electrophoresis distance for test samples may be insufficient or too long due to uncertainties during an electrophoresis test. So, the testers have to observe the electrophoresis condition of test samples on the field of the electrophoresis apparatuses repeatedly to determine whether to stop electrophoresis, which causes too much inconvenience to the testers.

Upon search, Chinese Invention Patent (Application No. 201710441204.2 and Application Date 2017.06.13) discloses a portable electrophoresis and photographing device and a using method thereof. The portable electrophoresis and photographing device and the using method thereof comprise a sealed box made of a light-proof material, wherein a sliding door is disposed on one side wall of the box, an observation platform is disposed in the box, an electrophoresis tank is disposed on the observation platform, an ultraviolet lamp and electrode columns are disposed in the electrophoresis tank, electrode bars connected to a power supply are disposed on the observation platform outside the electrophoresis tank, a viewing port provided with ultraviolet filter glass is disposed at the top of the box, a wide-angle optical lens provided with a multi-layer antireflection film is also disposed at the top of the interior of the box, a disk-shaped LED lamp aligned with the observation platform is disposed in the box, an ultraviolet lamp towards the observation platform is disposed on the inner wall of the box, and a UV lens for eliminating ultraviolet rays and stray light is disposed on the optical lens in the box. However, this application has the defect that the electrophoresis process cannot be remotely monitored or controlled in real time.

Chinese Invention Patent (Application No. 201810104781.7 and Application Date 2018.06.05) discloses an electrophoresis apparatus for visible light within a specific band, which comprises a main base capable of transmitting visible light within a specific band, and an electrophoresis tank, wherein the electrophoresis tank is secured on a gel cutting table disposed on the top plane of the main base; the electrophoresis tank is composed of a tank body and a tank cover, a viewing port is formed in the tank cover, and a liquid material for gel electrophoresis is contained in the tank body; a positioning frame allowing to-be-tested gel to be placed thereon is disposed in the tank body; a transparent heating film used for heating the a cover body of the tank cover to prevent the viewing port from becoming blurry is disposed on the tank cover, and is adhered to the upper surface of the tank cover; a network camera located over the viewing port in the tank cover of the electrophoresis tank and used for remotely monitoring the test process in real time is connected to one side of the main base through a support, and the visible light within the specific band transmitted by the main base penetrates through the gel cutting table, the bottom of the tank body of the electrophoresis tank, and the liquid material to be irradiated onto the to-be-tested gel and stimulate a nucleic acid dye in the gel to be in a special color. Although this application can realize remote monitoring of the electrophoresis process through the network camera, accurate recognition and remote control cannot be realized.

### BRIEF SUMMARY OF THE INVENTION

### 1. The Technical Issue to be Settled by the Invention

The objective of the invention is to solve the problem that existing electrophoresis apparatuses cannot be accurately recognized or remotely controlled.

### 2. Technical Solution

To fulfill the above objective, the invention provides the following technical solution:

The invention provides a method for remote control of an electrophoresis apparatus based on image recognition, which comprises: connecting an electrophoresis apparatus to a camera device and an electrophoresis tank, and controlling the camera device and the electrophoresis tank by the electrophoresis apparatus; recording an electrophoresis process of the electrophoresis tank in real time by the camera device, and sending a video to the electrophoresis apparatus; sending the video to a remote control terminal by the electrophoresis apparatus; capturing video images frame by frame and then performing an analysis and comparison, by the remote control terminal; and when the electrophoresis process of the electrophoresis tank in one frame of image reaches an electrophoresis image end standard line set by the remote control terminal, sending, by the remote control terminal, a control signal to the electrophoresis apparatus and controlling the electrophoresis apparatus to stop an output, so as to stop electrophoresis of the electrophoresis tank.

Preferably, recording an electrophoresis process of the electrophoresis tank in real time by the camera device specifically comprise recording electrophoresis gel images of the electrophoresis tank in real time by the camera device, and an area of the electrophoresis gel images in a viewing frame of the camera device accounts for 80%-90% of an entire screen area of the viewing frame.

Preferably, the electrophoresis apparatus is connected to a plurality of camera devices; and when the electrophoresis process of the electrophoresis tank in one frame of image in the video recorded by one camera device reaches a set standard of electrophoresis images, the remote control terminal sends the control signal to the electrophoresis apparatus and controls the electrophoresis apparatus to stop the output, so as to stop the electrophoresis of the electrophoresis tank.

Preferably, in a case where the electrophoresis process of the electrophoresis tank in one frame of image reaches a set standard of electrophoresis images, the set standard is a standard line in electrophoresis gel images, the standard line is set by the remote control terminal, and when the electrophoresis process reaches the set standard, it indicates that an electrophoresis indicator reaches the standard line in the electrophoresis gel images.

Preferably, when the electrophoresis process of the electrophoresis tank in one frame of image reaches a set standard of electrophoresis images, the remote control terminal sends a prompt signal to an operator, and after the operator confirms that the electrophoresis process reaches the set standard, the remote control terminal sends the control signal to the electrophoresis apparatus and controls the electrophoresis apparatus to stop the output, so as to stop the electrophoresis of the electrophoresis tank.

Preferably, the electrophoresis apparatus comprises an interface module, a control module, a processing module and a display module which are electrically connected in sequence, the processing module is electrically connected to a data transmission module, the data transmission module is wirelessly connected to a cloud storage module and a remote control module, the interface module is an interface used for electrically connecting the camera device and the electrophoresis tank, acquires the video recorded by the camera device in real time, and transmits the video to the control module, the control module converts video data and then transmits the converted video data to the processing module, the processing module preprocesses the video data and then transmits the preprocessed video data to the data transmission module, the data transmission module wirelessly transmits the video data to the cloud storage module, the cloud storage module is wirelessly connected to the remote control module and transmits the data to the remote control module in real time, the remote control module performs an analysis and comparison on the video data sent from the cloud storage module and sends a control instruction, and the remote control module is the remote control terminal.

Preferably, the control module converts the video data into video signal data and transmits the video signal data to the processing module, and the processing module preforms denoising the video signal data and then transmits the video signal data to the data transmission module.

Preferably, the data transmission module sends the processed video data to the cloud storage module, the cloud storage module stores the video data and sends the video data to the remote control module, and after capturing the video frame by frame, the cloud storage module performs an analysis and comparison; when the electrophoresis process of the electrophoresis tank in one frame of image reaches a set standard, the remote control signal sends a control signal to the cloud storage module, the cloud storage module sends the control signal to the processing module, and the processing module controls an interface, connected to the electrophoresis apparatus, in the interface module through the control module to enable the electrophoresis apparatus to stop the output, so as to stop the electrophoresis of the electrophoresis tank.

Preferably, the display module is a display screen of the electrophoresis apparatus, the electrophoresis apparatus further comprises a control panel, the display screen is used for displaying a working state of the electrophoresis apparatus, the control panel is used for controlling the electrophoresis apparatus, and the control module is a control chip electrically connected to the control panel.

Preferably, a working state indicator is disposed on the camera device, and when the camera device records a video, the working state indicator lights up.

Preferably, the processing module is further electrically connected to a storage module, and the storage module is a memory of the electrophoresis apparatus and is used for storing work logs of the electrophoresis apparatus.

Preferably, the electrophoresis apparatus comprises a tank body, electrode receiving slots and a top cover, the top cover is used for covering and sealing the tank body and the electrode receiving slots, and electrodes are disposed in the electrode receiving slots and are electrically connected to the interface module.

Preferably, an electrophoresis gel layer is disposed in the tank body.

Preferably, the method for remote control of an electrophoresis apparatus based on image recognition further comprises setting a remind time, and reminding, by the remote control terminal, the operator to check the video at the set remind time and determine whether to stop the electrophoresis.

Preferably, if the electrophoresis process of the electrophoresis tank in one frame of image reaches a set standard of electrophoresis images before the remind time, the remote control terminal sends a prompt signal to the operator; and after the operator confirms that the electrophoresis process reaches the set standard of electrophoresis images, the remote control terminal sends the control signal to the electrophoresis apparatus and controls the electrophoresis apparatus to stop the output, so as to stop the electrophoresis of the electrophoresis tank.

### 3. Beneficial Effects

Compared with the prior art, the technical solution provided by the invention has the following beneficial effects:

According to the method for remote control of an electrophoresis apparatus based on image recognition, the electrophoresis apparatus is connected to and controls the camera device and the electrophoresis tank, the camera device records the electrophoresis process of the electrophoresis tank in real time and sends a video to the electrophoresis apparatus, the electrophoresis apparatus sends the video to the remote control terminal, the remote control terminal performs an analysis and comparison after capturing video images frame by frame, and when the electrophoresis process of the electrophoresis tank in one frame of image reaches the electrophoresis image end standard line set by the remote control terminal, the remote control terminal sends a control signal to the electrophoresis apparatus and controls the electrophoresis apparatus to stop an output, so as to stop electrophoresis of the electrophoresis tank. The electrophoresis process can be monitored and controlled remotely through the remote control terminal, such that the electrophoresis process can be monitored and controlled conveniently, and the manual monitoring time is saved for operators.

### BRIEF DESCRIPTION OF THE SEVERAL VIEWS OF THE DRAWINGS

FIG. 1 is a structural diagram of functional modules for a method according to the invention;

FIG. 2 is a first structural diagram of a device according to the invention;

FIG. 3 is a second structural diagram of the device according to the invention.

### REFERENCE SIGNS

10, electrophoresis apparatus; 11, control panel; 12, display screen; 20, electrophoresis tank; 21, tank body; 22, electrode receiving slot; 23, top cover; 24, electrode; 30, camera device; 100, interface module; 200, control module; 300, processing module; 400, display module; 500, storage module; 600, data transmission module; 700, cloud storage module; 800, remote control module.

### DETAILED DESCRIPTION OF THE INVENTION

For the sake of a better understanding of the invention, the invention will be described more comprehensively below with reference to relevant accompanying drawings. The drawings illustrate several embodiments of the invention, but the invention may be implemented in different forms and is not limited to the embodiments described below. These embodiments are provided for the purpose of making the contents of the invention be understood more thoroughly and comprehensively.

It should be noted that, when one element is “fixedly disposed” on the other element, it may be directly located on the other element or an element may exist between these two elements; when one element is “connected” to the other element, it may be directly connected to the other element or an element may exist between these two elements; and terms such as “vertical”, “horizontal”, “left” and “right” and similar expressions in this specification are merely for a descriptive purpose.

Unless otherwise defined, all technical and scientific terms used in this specification have the same meanings as those commonly understood by those skilled in the art; the terms used in this specification of the invention are merely for the purpose of describing specific embodiments, and are not intended to limit the invention; and the term “and/or” used in this specification includes any and all combinations of one or more relevant items listed

### Embodiment 1

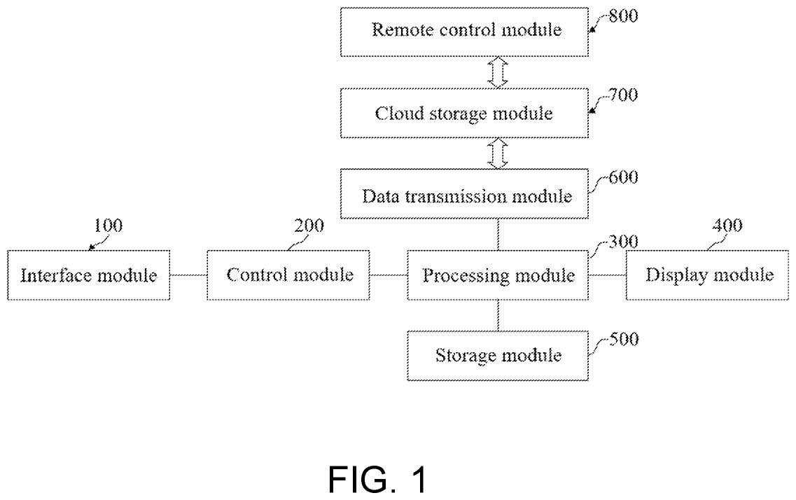

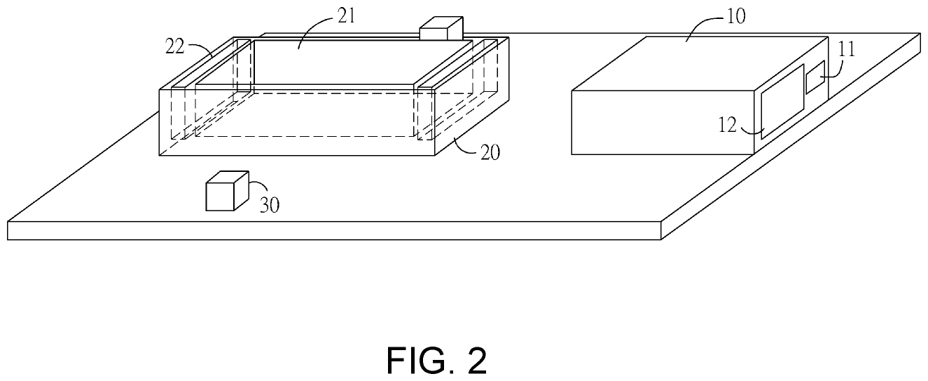

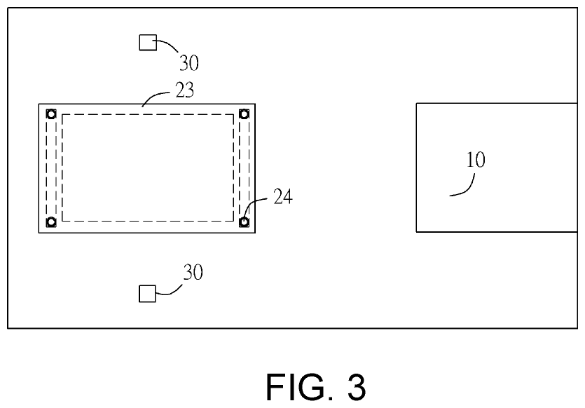

Referring to FIG. 1-FIG. 3, this embodiment provides a method for remote control of an electrophoresis apparatus based on image recognition, comprising: connecting an electrophoresis apparatus 10 to a camera device 30 and an electrophoresis tank 20, and controlling the camera device 30 and the electrophoresis tank 20 by the electrophoresis apparatus 10; recording an electrophoresis process of the electrophoresis tank 20 in real time by the camera device 30, and sending a video to the electrophoresis apparatus 10; sending the video to a remote control terminal by the electrophoresis apparatus 10; capturing video images frame by frame and then performing an analysis and comparison, by the remote control terminal; and when the electrophoresis process of the electrophoresis tank 20 in one frame of image reaches a set standard of electrophoresis images, sending, by the remote control terminal, a control signal to the electrophoresis apparatus 10 and controlling the electrophoresis apparatus to stop an output, so as to stop electrophoresis of the electrophoresis tank 20. The electrophoresis process can be monitored and controlled remotely through the remote control terminal, such that the electrophoresis process can be monitored and controlled conveniently, and the manual monitoring time is saved for operators.

In this embodiment, recording an electrophoresis process of the electrophoresis tank 20 in real time by the camera device 30 specifically comprise recording electrophoresis gel images of the electrophoresis tank 20 in real time by the camera device 3, and the area of the electrophoresis gel images in a viewing frame of the camera device 30 accounts for 80%-90% of an entire screen area of the viewing frame.

In this embodiment, the electrophoresis apparatus is connected to a plurality of camera devices 30; and when the electrophoresis process of the electrophoresis tank 20 in one frame of image in the video recorded by one camera device 30 reaches the set standard of electrophoresis images, the remote control terminal sends the control signal to the electrophoresis apparatus 10 and controls the electrophoresis apparatus to stop the output, so as to stop the electrophoresis of the electrophoresis tank 20.

In this embodiment, in a case where the electrophoresis process of the electrophoresis tank 20 in one frame of image reaches the set standard of electrophoresis images, the set standard is a standard line in electrophoresis gel images, the standard line is set by the remote control terminal, and when the electrophoresis process reaches the set standard, it indicates that an electrophoresis indicator reaches or is close to the standard line in the electrophoresis gel images.

In the case where the electrophoresis process of the electrophoresis tank 20 in one frame of image reaches the set standard of electrophoresis images, set standard of electrophoresis images may be a standard that the electrophoresis is completed, or a standard that the electrophoresis is about to be completed, which is 80%-90% of the standard that the electrophoresis is completed.

The remote control terminal sends a prompt signal to an operator, and after the operator confirms that the electrophoresis process reaches the set standard, the remote control terminal sends the control signal to the electrophoresis apparatus 10 and controls the electrophoresis apparatus to stop the output, so as to stop the electrophoresis of the electrophoresis tank 20.

In this embodiment, the electrophoresis apparatus 20 comprises an interface module 100, a control module 200, a processing module 300 and a display module 400 which are electrically connected in sequence, wherein the processing module 300 is electrically connected to a data transmission module 600, the data transmission module 600 is wirelessly connected to a cloud storage module 700 and a remote control module 800, the interface module 100 is an interface used for electrically connecting the camera device 30 and the electrophoresis tank 20, and acquires a video recorded by the camera device 30 in real time and transmits the video to the control module 200, the control module 200 converts video data and transmits the converted video data to the processing module 300, the processing module 300 preprocesses the video data and then transmits the preprocessed video data to the data transmission module 600, the data transmission module 600 wirelessly transmits the video data to the cloud storage module 700, the cloud storage module 700 is wirelessly connected to the remote control module 800 and transmits data in real time, the remote control module 800 is used for performing a comparison and analysis on the video data sent from the cloud storage module 700, and the remote control module 800 is the remote control terminal.

In this embodiment, the control module 200 converts the video data into video signal data and transmits the video signal data to the processing module 300, and the processing module 300 perform denoising on the video signal data and then sends the video signal to the data transmission module 600.

In this embodiment, the data transmission module 600 sends the processed video data to the cloud storage module 700, the cloud storage module 700 stores the video data and sends the video data to the remote control module 800, and after capturing the video frame by frame, the cloud storage module 700 performs an analysis and comparison; when the electrophoresis process of the electrophoresis tank 20 in one frame of image reaches the set standard of electrophoresis image, the remote control module 800 sends a control signal to the cloud storage module 700; the cloud storage module 700 sends the control signal to the processing module 300, and processing module 300 controls an interface, connected to the electrophoresis apparatus 10, in the interface module 100 through the control module 200 to enable the electrophoresis apparatus stop the output, so as to stop the electrophoresis of the electrophoresis tank 20.

In this embodiment, the display module 400 is a display screen 12 of the electrophoresis apparatus 10, the electrophoresis apparatus 10 further comprises a control panel 11, the display screen 12 is used for displaying the working state of the electrophoresis apparatus 10, the control module 11 is used for controlling the electrophoresis apparatus 10, and the control module 200 is a control chip electrically connected to the control panel 11.

In this embodiment, a working state indicator is disposed on the camera device 30, and when the camera device 30 records a video, the working state indicator lights up.

In this embodiment, the processing module 300 is further electrically connected to a storage module 500, and the storage module 500 is a memory of the electrophoresis apparatus 10 and is used for storing work logs of the electrophoresis apparatus 10.

In this embodiment, the electrophoresis apparatus 10 comprises a tank body 21, electrode receiving slots 22 and a top cover 23, wherein the top cover 23 is used for covering and sealing the tank body 21 and the electrode receiving slots 22, and electrodes 24 are disposed in the electrode receiving slots 22 and are electrically connected to the interface module 100.

In this embodiment, an electrophoresis gel layer is disposed in the tank body 21.

The method for remote control of an electrophoresis apparatus based on image recognition further comprises setting a remind time, and reminding, by the remote control terminal, the operator to check the video at the set remind time and determine whether to stop the electrophoresis, wherein the set remind time is less than a theoretical electrophoresis completion time and greater than 85% of the theoretical electrophoresis completion time.

If the electrophoresis process of the electrophoresis tank 20 in one frame of image reaches a set standard of electrophoresis images before the remind time, the remote control terminal sends a prompt signal to the operator; and after the operator confirms that the electrophoresis process reaches the set standard of electrophoresis images, the remote control terminal sends the control signal to the electrophoresis apparatus 10 and controls the electrophoresis apparatus to stop the output, so as to stop the electrophoresis of the electrophoresis tank 20.

The above embodiments merely illustrate some implementations of the invention and are specifically described in detail, but these embodiments should not be construed as limitations of the patent scope of the invention. It should be pointed out that several modifications and improvements may be made by those ordinarily skilled in the art without departing from the concept of the invention, and all these modifications and improvements should fall within the protection scope of the invention. Thus, the protection scope of the patent of invention should be defined by the appended claims.

1. A method for remote control of an electrophoresis apparatus based on image recognition, comprising: connecting an electrophoresis apparatus to a camera device and an electrophoresis tank, and controlling the camera device and the electrophoresis tank by the electrophoresis apparatus; recording an electrophoresis process of the electrophoresis tank in real time by the camera device, and sending a video to the electrophoresis apparatus; sending the video to a remote control terminal by the electrophoresis apparatus; capturing video images frame by frame and then performing an analysis and comparison, by the remote control terminal; and when the electrophoresis process of the electrophoresis tank in one frame of image reaches an electrophoresis image end standard line set by the remote control terminal, sending, by the remote control terminal, a control signal to the electrophoresis apparatus and controlling the electrophoresis apparatus to stop an output, so as to stop electrophoresis of the electrophoresis tank.

2. The method for remote control of an electrophoresis apparatus based on image recognition according to claim 1, wherein recording an electrophoresis process of the electrophoresis tank in real time by the camera device specifically comprise recording electrophoresis gel images of the electrophoresis tank in real time by the camera device, and an area of the electrophoresis gel images in a viewing frame of the camera device accounts for 80%-90% of an entire screen area of the viewing frame.

3. The method for remote control of an electrophoresis apparatus based on image recognition according to claim 1, wherein the electrophoresis apparatus is connected to a plurality of said camera devices; and when the electrophoresis process of the electrophoresis tank in one frame of image in the video recorded by one said camera device reaches a set standard of electrophoresis images, the remote control terminal sends the control signal to the electrophoresis apparatus and controls the electrophoresis apparatus to stop the output, so as to stop the electrophoresis of the electrophoresis tank.

4. The method for remote control of an electrophoresis apparatus based on image recognition according to claim 1, wherein in a case where the electrophoresis process of the electrophoresis tank in one frame of image reaches a set standard of electrophoresis images, the set standard is a standard line in electrophoresis gel images, the standard line is set by the remote control terminal, and when the electrophoresis process reaches the set standard, it indicates that an electrophoresis indicator reaches the standard line in the electrophoresis gel images.

5. The method for remote control of an electrophoresis apparatus based on image recognition according to claim 1, wherein when the electrophoresis process of the electrophoresis tank in one frame of image reaches a set standard of electrophoresis images, the remote control terminal sends a prompt signal to an operator, and after the operator confirms that the electrophoresis process reaches the set standard, the remote control terminal sends the control signal to the electrophoresis apparatus and controls the electrophoresis apparatus to stop the output, so as to stop the electrophoresis of the electrophoresis tank.

6. The method for remote control of an electrophoresis apparatus based on image recognition according to claim 1, wherein the electrophoresis apparatus comprises an interface module, a control module, a processing module and a display module which are electrically connected in sequence, the processing module is electrically connected to a data transmission module, the data transmission module is wirelessly connected to a cloud storage module and a remote control module, the interface module is an interface used for electrically connecting the camera device and the electrophoresis tank, acquires the video recorded by the camera device in real time, and transmits the video to the control module, the control module converts video data and then transmits the converted video data to the processing module, the processing module preprocesses the video data and then transmits the preprocessed video data to the data transmission module, the data transmission module wirelessly transmits the video data to the cloud storage module, the cloud storage module is wirelessly connected to the remote control module and transmits the data to the remote control module in real time, the remote control module performs an analysis and comparison on the video data sent from the cloud storage module and sends a control instruction, and the remote control module is the remote control terminal.

7. The method for remote control of an electrophoresis apparatus based on image recognition according to claim 6, wherein the control module converts the video data into video signal data and transmits the video signal data to the processing module, and the processing module preforms denoising the video signal data and then transmits the video signal data to the data transmission module.

8. The method for remote control of an electrophoresis apparatus based on image recognition according to claim 7, wherein the data transmission module sends the processed video data to the cloud storage module, the cloud storage module stores the video data and sends the video data to the remote control module, and after capturing the video frame by frame, the cloud storage module performs an analysis and comparison; when the electrophoresis process of the electrophoresis tank in one frame of image reaches a set standard, the remote control signal sends a control signal to the cloud storage module, the cloud storage module sends the control signal to the processing module, and the processing module controls an interface, connected to the electrophoresis apparatus, in the interface module through the control module to enable the electrophoresis apparatus to stop the output, so as to stop the electrophoresis of the electrophoresis tank.

9. The method for remote control of an electrophoresis apparatus based on image recognition according to claim 8, wherein the display module is a display screen of the electrophoresis apparatus, the electrophoresis apparatus further comprises a control panel, the display screen is used for displaying a working state of the electrophoresis apparatus, the control panel is used for controlling the electrophoresis apparatus, and the control module is a control chip electrically connected to the control panel.

10. The method for remote control of an electrophoresis apparatus based on image recognition according to claim 8, wherein a working state indicator is disposed on the camera device, and when the camera device records a video, the working state indicator lights up.

11. The method for remote control of an electrophoresis apparatus based on image recognition according to claim 8, wherein the processing module is further electrically connected to a storage module, and the storage module is a memory of the electrophoresis apparatus and is used for storing work logs of the electrophoresis apparatus.

12. The method for remote control of an electrophoresis apparatus based on image recognition according to claim 8, wherein the electrophoresis apparatus comprises a tank body, electrode receiving slots and a top cover, the top cover is used for covering and sealing the tank body and the electrode receiving slots, and electrodes are disposed in the electrode receiving slots and are electrically connected to the interface module.

13. The method for remote control of an electrophoresis apparatus based on image recognition according to claim 12, wherein an electrophoresis gel layer is disposed in the tank body.

14. The method for remote control of an electrophoresis apparatus based on image recognition according to claim 5, further comprising setting a remind time, and reminding, by the remote control terminal, the operator to check the video at the set remind time and determine whether to stop the electrophoresis.

15. The method for remote control of an electrophoresis apparatus based on image recognition according to claim 14, wherein if the electrophoresis process of the electrophoresis tank in one frame of image reaches a set standard of electrophoresis images before the remind time, the remote control terminal sends a prompt signal to the operator; and after the operator confirms that the electrophoresis process reaches the set standard of electrophoresis images, the remote control terminal sends the control signal to the electrophoresis apparatus and controls the electrophoresis apparatus to stop the output, so as to stop the electrophoresis of the electrophoresis tank.
